(19) United States
(12) Patent Application Publication
(10) Pub. No.: US 2026/0266351 A1
(43) Pub. Date: Sep. 10, 2026

(54) SHOCK ABSORBER

(71) Applicant: KYB Motorcycle Suspension Co.,Ltd, Gifu (JP)

(72) Inventor: Wataru ISHIHARA, Gifu (JP)

(73) Assignee: KYB Motorcycle Suspension Co.,Ltd, Gifu (JP)

(21) Appl. No.: 19/555,353

(22) Filed: Mar. 3, 2026

(30) Foreign Application Priority Data
Mar. 10, 2025 (JP) 2025-037255

(51) Int. Cl. F16F 13/00; F16F 9/32; F16F 9/38

(52) U.S. Cl. CPC F16F 13/007; F16F 9/3235; F16F 9/38; F16F 2230/0005; F16F 2230/0023; F16F 2230/02; F16F 2232/08; F16F 2234/02

(57) ABSTRACT

A shock absorber according to the present invention includes: a shock absorber main body that includes an outer tube and a rod and generates a damping force during extension and compression; an outer-tube-side spring seat that is attached to an outer periphery of the outer tube; a rod-side spring seat that is attached to the rod; a coil spring that is interposed between the outer-tube-side spring seat and the rod-side spring seat; and a protector that covers a part of the outer periphery of the outer tube to prevent an interference between the coil spring and the outer tube, in which a groove is provided on an outer periphery of a protector mounting portion on which the protector is mounted, and the protector includes a tubular protector main body and a fixing projection that is provided on an inner periphery of the protector main body and fitted into the groove to fix the protector main body to the outer tube.

### BACKGROUND

### Technical Field

The present invention relates to a shock absorber.

### Related Art

A shock absorber used in a straddled vehicle such as a motorcycle, a snowmobile, or an all-terrain vehicle includes, for example, a shock absorber main body including a cylinder, a rod movably inserted into the cylinder, and a piston coupled to the rod and slidably inserted into the cylinder, and a coil spring interposed between the rod and the cylinder to elastically support a vehicle body of the straddled vehicle.

In the case of such a shock absorber integrally provided with the coil spring, it may be required to reduce an outer diameter of the coil spring from the viewpoint of mountability on the straddled vehicle. On the other hand, in a case where the shock absorber is required to exhibit a high damping force, it is necessary to increase the cylinder diameter in order to increase the cross-sectional area of the piston.

When the outer diameter of the coil spring is reduced from the viewpoint of mountability, the aspect ratio of the coil spring increases, and the coil spring is likely to buckle when the shock absorber is compressed. Therefore, when the cylinder diameter is increased to meet the demand for exhibition of a high damping force, the coil spring may buckle and interfere with the cylinder during a compression operation of the shock absorber, and the deterioration of the cylinder and the coil spring may be accelerated.

Therefore, in a shock absorber according to a related art as disclosed in JP 2016-142299 A, for example, a tubular protector is mounted on an outer periphery in the vicinity of an end portion on a rod side of a cylinder facing the vicinity of the center of a coil spring in an axial direction, so that even if the coil spring buckles, the protector prevents an interference between the coil spring and the cylinder to protect the coil spring and the cylinder.

### SUMMARY

In the shock absorber according to the related art, when the protector is fixed to the cylinder, two annular grooves formed in a peripheral direction are provided at the end portion on the rod side of the cylinder, a C-shaped stopper ring is assembled to one annular groove on a non-rod side of the cylinder, the protector is fitted onto an outer periphery of the cylinder, and then the stopper ring is mounted on the other annular groove on a rod side, so that the protector is sandwiched between the two stopper rings.

As described above, in the shock absorber according to the related art, two stopper rings are mounted on the cylinder, and the protector is fixed to the cylinder in a state of being sandwiched between the two stopper rings. However, work of mounting the stopper rings on the cylinder is troublesome, and workability in an assembly process is poor. In addition, when a load in an axial direction is applied to the stopper ring, there is a possibility that the stopper ring expands in diameter and comes out of the annular groove. Therefore, there is a possibility that the protector is detached from the cylinder.

Therefore, an object of the present invention is to provide a shock absorber capable of improving assembly workability and suppressing detachment of a protector.

In order to solve the above problems, a shock absorber according to the present invention includes: a shock absorber main body that includes an outer tube and a rod inserted into the outer tube so as to be movable in an axial direction and is configured to generate a damping force during extension and compression; an outer-tube-side spring seat that is attached to an outer periphery of the outer tube; a rod-side spring seat that is attached to the rod; a coil spring that is interposed between the outer-tube-side spring seat and the rod-side spring seat in a state in which the outer tube and the rod are inserted into an inner periphery of the coil spring; and a protector that covers a part of the outer periphery of the outer tube to prevent an interference between the coil spring and the outer tube, in which a groove is provided on an outer periphery of a protector mounting portion on which the protector is mounted, and the protector includes a tubular protector main body and a fixing projection that is provided on an inner periphery of the protector main body and fitted into the groove to fix the protector main body to the outer tube.

In the shock absorber configured as described above, when the protector is fixed to the outer tube, the protector can be easily assembled to the outer tube by fitting the fixing projection of the protector into the groove formed on the outer periphery of the outer tube without requiring two stopper rings as in the shock absorber according to the related art. Since the protector does not have a C shape like the stopper ring, there is no concern that the protector is expanded in diameter and the fixing projection comes out of the groove even when a force in the axial direction is applied, and the protector can be firmly fixed to the outer tube.

### BRIEF DESCRIPTION OF DRAWINGS

FIG. 1 is a partially cutaway side view of a shock absorber according to one embodiment;

FIG. 2 is a view for describing an assembly process for the shock absorber;

FIG. 3 is a plan view of a modified example of a protector;

FIG. 4 is a plan view of another modified example of the protector; and

FIG. 5 is a cross-sectional view of a part of a shock absorber according to a modified example of one embodiment.

### DETAILED DESCRIPTION

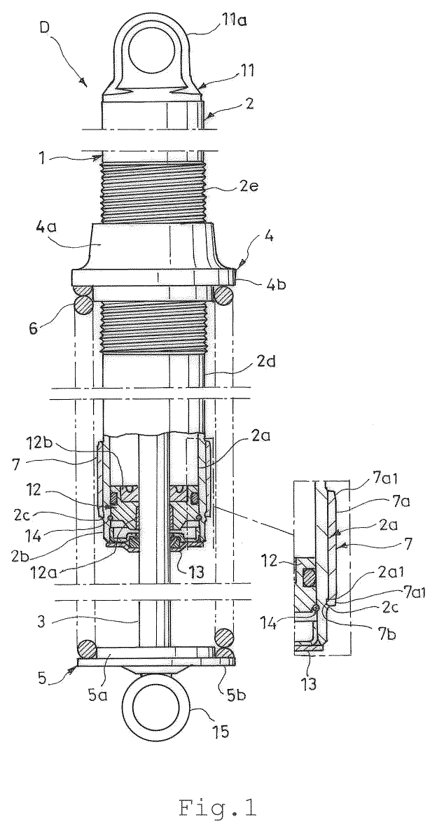

The present invention will be described based on an embodiment illustrated in the drawing. As illustrated in FIG. 1, a shock absorber D according to one embodiment includes a shock absorber main body 1 that includes an outer tube 2 and a rod 3 inserted into the outer tube 2 so as to be movable in an axial direction and generates a damping force during extension and compression, an outer-tube-side spring seat 4 that is attached to an outer periphery of the outer tube 2, a rod-side spring seat 5 that is attached to the rod 3, a coil spring 6 that is interposed between the outer-tube-side spring seat 4 and the rod-side spring seat 5 in a state in which the outer tube 2 and the rod 3 are inserted into an inner periphery of the coil spring 6, and a protector 7 that covers a part of the outer periphery of the outer tube 2 to prevent an interference between the coil spring 6 and the outer tube 2. Although not illustrated, for example, the shock absorber D is interposed between a sprung member serving as a vehicle body in a motorcycle, a snowmobile, an all-terrain vehicle, or other straddled vehicles and an unsprung member such as a wheel, and generates a damping force during extension and compression to suppress vibration of the sprung member.

Hereinafter, each part of the shock absorber D will be described. The shock absorber main body 1 includes the outer tube 2 and the rod 3 inserted into the outer tube 2 so as to be movable in the axial direction. For example, although not illustrated, the shock absorber main body 1 includes a piston that is coupled to the rod 3, is inserted into the outer tube 2 so as to be movable in the axial direction, and partitions the inside of the outer tube 2 into an extension side chamber and a compression side chamber, which are filled with hydraulic oil, and a damping passage that communicates the extension side chamber and the compression side chamber. The shock absorber main body 1 applies a resistance to a flow of the hydraulic oil that moves back and forth between the extension side chamber and the compression side chamber during extension and compression through the damping passage to generate a damping force that hinders extension and compression.

As illustrated in FIG. 1, the outer tube 2 includes: a protector mounting portion 2a provided on the outer periphery in the vicinity of a lower end of the outer tube 2, having a larger outer diameter, and on which the protector 7 is mounted; a rod-side end portion 2b provided on the outer periphery on a lower end side in FIG. 1, positioned on a rod side with respect to the protector mounting portion 2a, and having an outer diameter smaller than the outer diameter of the protector mounting portion 2a; a tapered portion 2c provided on the outer periphery between the rod-side end portion 2b and the protector mounting portion 2a and having an outer diameter increasing from the rod-side end portion 2b toward the protector mounting portion 2a; a small-diameter portion 2d provided on the outer periphery, positioned on an upper side in FIG. 1, which is a non-rod side with respect to the protector mounting portion 2a, and having an outer diameter smaller than the outer diameter of the protector mounting portion 2a; and a screw portion 2e provided on the outer periphery, positioned on the upper side in FIG. 1, which is a non-rod side with respect to the small-diameter portion 2d, and having an outer diameter larger than the outer diameter of the small-diameter portion 2d.

Further, the protector mounting portion 2a of the outer tube 2 is provided with an annular groove 2a1 formed over the entire periphery in a peripheral direction on an outer periphery of the protector mounting portion 2a and in the vicinity of a lower end of the protector mounting portion 2a in FIG. 1.

A head cap 11 is mounted on an upper end of the outer tube 2 in FIG. 1. The head cap 11 closes an opening end of the upper end of the outer tube 2 and includes an eye-type bracket 11a. Therefore, the shock absorber main body 1 can be coupled to the sprung member in the straddled vehicle (not illustrated) by using the eye-type bracket 11a of the head cap 11.

In the outer tube 2 configured as described above, a free piston (not illustrated) is accommodated in the outer tube 2 so as to be movable in the axial direction, and the inside of the outer tube 2 is partitioned by the free piston into a liquid chamber filled with the hydraulic oil in the extension side chamber and the compression side chamber, and a gas chamber filled with gas. The free piston can expand one of the liquid chamber and the gas chamber in the outer tube 2 and reduce the other by moving in the outer tube 2. The gas chamber is filled with gas such that a pressure becomes equal to or higher than the atmospheric pressure even when the free piston maximally expands the gas chamber, and the liquid chamber is pressurized such that a pressure becomes equal to or higher than the atmospheric pressure by the pressure in the gas chamber.

An upper end side of the rod 3 is inserted into the outer tube 2 through inner peripheries of an annular sealing case 12 and an annular cap 13 provided at the lower end of the outer tube 2 in FIG. 1, and a lower end side of the rod 3 protrudes to the outside of the outer tube 2.

The sealing case 12 has an annular shape and has an inner peripheral side on which a tubular bush 12a that is slidably in contact with an outer periphery of the rod 3, and a sealing ring 12b that is slidably in contact with the outer periphery of the rod 3 and seals the outer periphery of the rod 3 are provided, the sealing case 12 being accommodated on an inner periphery of the lower end of the outer tube 2 in FIG. 1. In addition, the sealing case 12 is restricted from coming out of the outer tube 2 by a stopper ring 14 mounted on an inner periphery of the outer tube 2, and is constantly biased toward the outside of the outer tube 2 by a pressure in the outer tube 2. Therefore, the sealing case 12 is positioned at a position abutting on the stopper ring 14 without moving upward in the outer tube 2 in FIG. 1.

The cap 13 is fixed by press-fitting to the inner periphery of the outer tube 2 at a position below a mounting position of the sealing case 12.

The shock absorber main body 1 configured as described above exerts a damping force that prevents extension/compression of the shock absorber main body 1 by applying a resistance to the flow of the hydraulic oil moving back and forth between the extension side chamber and the compression side chamber through a damping valve provided in the piston during an extension/compression operation in which the piston (not illustrated) moves in a vertical direction in FIG. 1 together with the rod 3 in the outer tube 2. In addition, during the extension/compression operation of the shock absorber main body 1, the rod 3 moves in and out of the outer tube 2 and a volume of the rod 3 entering the outer tube 2 thus changes, and the free piston moves up and down in the outer tube 2 to expand and contract the liquid chamber and the gas chamber, thereby compensating for the change in the volume.

Here, the change in the volume of the rod 3 in the outer tube 2 is compensated by providing the gas chamber in the outer tube 2. However, the change in the volume may also be compensated by providing a tank including a gas chamber and a liquid chamber communicating with the compression side chamber outside the outer tube 2. In addition, a cylinder may be provided inside the outer tube 2, the piston may be slidably inserted into the cylinder to form the extension side chamber and the compression side chamber in the cylinder, and a reservoir that is filled with gas and liquid and communicates with the compression side chamber may be provided between the cylinder and the outer tube 2 to compensate for the change in the volume. Furthermore, when the tank or the reservoir is provided as described above, a damping valve or a variable damping valve capable of adjusting the damping force may be provided in a passage connecting the compression side chamber and the tank or reservoir.

The outer-tube-side spring seat 4 is attached to the screw portion 2e provided on the outer periphery of the outer tube 2. The outer-tube-side spring seat 4 has an annular shape and includes a nut portion 4a screwed to the screw portion 2e of the outer tube 2 and a flange-shaped spring seat 4b provided on an outer periphery of the nut portion 4a. Therefore, when the outer-tube-side spring seat 4 is rotationally operated with respect to the outer tube 2, the outer-tube-side spring seat 4 can move in the axial direction with respect to the outer tube 2, and a position with respect to the outer tube 2 can be adjusted in the vertical direction in FIG. 1.

An eye-type bracket 15 capable of being coupled to the unsprung member in the straddled vehicle (not illustrated) is attached to a lower end of the rod 3. The rod-side spring seat 5 is attached to the rod 3 via the eye-type bracket 15 and is disposed on an outer periphery of the lower end of the rod 3. Although not illustrated, a tubular cushion that is fitted onto the outer periphery of the rod 3 and abuts on the cap 13 at the time of maximum compression of the shock absorber D to mitigate an impact is attached to an upper side of the rod-side spring seat 5 in FIG. 1.

The rod-side spring seat 5 includes a recessed fitting portion 5a that is annular and is fitted to an upper end of the eye-type bracket 15 in FIG. 1, and a flange-shaped spring seat 5b provided on an outer periphery of the fitting portion 5a.

The coil spring 6 is interposed between the spring seat 4b of the outer-tube-side spring seat 4 and the spring seat 5b of the rod-side spring seat 5. An inner periphery of an upper end of the coil spring 6 is fitted to the outer periphery of the nut portion 4a of the outer-tube-side spring seat 4, and an inner periphery of a lower end of the coil spring 6 is fitted to the outer periphery of the fitting portion 5a of the rod-side spring seat 5. Movement of the upper end of the coil spring 6 in a radial direction with respect to the spring seat 4b is restricted, and movement of the lower end of the coil spring 6 in the radial direction with respect to the spring seat 5b is restricted.

The coil spring 6 is interposed between the outer-tube-side spring seat 4 and the rod-side spring seat 5 in a compressed state, and biases the shock absorber main body 1 in a direction in which the shock absorber main body 1 is constantly extended.

The protector 7 includes a tubular protector main body 7a and a fixing projection 7b that is provided on an inner periphery of the protector main body 7a and fitted into the groove 2a1 provided in the protector mounting portion 2a of the outer tube 2 to fix the protector main body 7a to the outer tube 2, the protector 7 being made of a synthetic resin. The protector 7 is preferably made of a synthetic resin having a self-lubricating property so as not to generate a large frictional force with the coil spring 6 when colliding with the coil spring 6.

When mounted on the protector mounting portion 2a of the outer tube 2, the protector 7 covers the protector mounting portion 2a forming a part of the outer periphery of the outer tube 2 and protects the outer tube 2 from the coil spring 6.

The protector main body 7a has a tubular shape, includes chamfered portions 7a1 having a tapered shape and provided on outer peripheries of an upper end and a lower end of the protector main body 7a, and is fitted onto the outer periphery of the protector mounting portion 2a. An inner diameter of the protector main body 7a is set so as to allow fitting onto the outer periphery of the protector mounting portion 2a. Even if the protector 7 is made of a synthetic resin and is made of a hard synthetic resin, the protector 7 can be elastically deformed, and the protector main body 7a is allowed to expand in diameter when the protector mounting portion 2a is inserted into the protector main body 7a. Therefore, the inner diameter of the protector main body 7a may be slightly smaller than the outer diameter of the protector mounting portion 2a. It is a matter of course that the inner diameter of the protector main body 7a may be slightly larger than the outer diameter of the protector mounting portion 2a to such an extent that the protector main body 7a can be loosely fitted onto the outer periphery of the protector mounting portion 2a.

The fixing projection 7b is an annular protrusion that protrudes inward in the radial direction from an inner periphery of a rod-side end that is the lower end of the protector main body 7a in FIG. 1, and a length in the axial direction and a length in the radial direction are set so as to allow fitting into the groove 2a1 of the protector mounting portion 2a. An inner diameter of the fixing projection 7b is smaller than an outer diameter which is a diameter of the outer periphery of the protector mounting portion 2a, and is equal to or larger than an outer diameter of the rod-side end portion 2b positioned on the rod side with respect to the protector mounting portion 2a.

The protector 7 configured as described above is assembled to the protector mounting portion 2a of the outer tube 2 as follows. First, the lower end in FIG. 1, which is a rod-side end of the outer tube 2, is inserted into the protector 7 from a lower end side in FIG. 1, the protector main body 7a is fitted onto the outer periphery of the protector mounting portion 2a, and the rod-side end of the outer tube 2 is temporarily inserted into the protector 7 in a state in which the fixing projection 7b faces the rod-side end portion 2b in the radial direction.

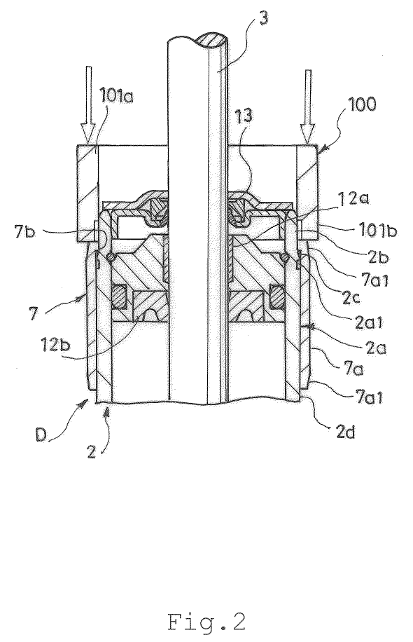

Then, as illustrated in FIG. 2, from a state in which the outer tube 2 is temporarily inserted into the protector 7, the protector 7 is pushed by a jig 100 until the fixing projection 7b is fitted into the groove 2a1 in a state in which a rod-side end of the protector 7, which is an upper end in FIG. 2, faces the outer tube 2, so that the protector 7 is mounted on the outer periphery of the protector mounting portion 2a. In a manufacturing process for the shock absorber D of the present embodiment, in a process of pushing the protector 7 toward the outer tube 2 by using the jig 100, a process of pushing the cap 13 toward the inner periphery of the outer tube 2 by using the jig 100 and press-fitting the cap 13 into the outer tube 2 is performed simultaneously. Therefore, the jig 100 includes an annular portion 101a that has an annular shape and can abut on an upper end of the cap 13 in FIG. 2, and a cylindrical portion 101b that extends from a lower end of the annular portion 101a in FIG. 2, faces an outer periphery of the rod-side end portion 2b of the outer tube 2, and abuts on the rod-side end of the protector 7. Therefore, the cap 13 and the protector 7 can be mounted on the outer tube 2 by bringing the jig 100 close to the outer tube 2 after the cap 13 is lightly pushed toward the inner periphery of the outer tube 2 and the outer tube 2 is temporarily inserted into the protector 7.

In a process of mounting the protector 7 on the protector mounting portion 2a, the fixing projection 7b rides up onto the tapered portion 2c provided on the outer periphery of the outer tube 2 and between the protector mounting portion 2a and the rod-side end portion 2b. Therefore, as the protector 7 is pushed toward the outer tube 2, the fixing projection 7b is smoothly expanded in diameter using an inclined surface of the tapered portion 2c, so that workability for fitting the fixing projection 7b into the groove 2a1 is improved. Although the tapered portion 2c between the protector mounting portion 2a and the rod-side end portion 2b in the outer tube 2 may be eliminated, in this case, when a tapered surface is provided on an inner periphery of a non-rod-side end, which is a lower end of the fixing projection 7b in FIG. 2, it is possible to promote smooth diameter expansion of the fixing projection 7b in a mounting process for the protector 7, thereby improving workability.

In the mounting process for the protector 7, when the protector 7 moves downward with respect to the outer tube 2 in FIG. 2 to a position where the fixing projection 7b faces the groove 2a1, the fixing projection 7b which rides up onto the protector mounting portion 2a and is expanded in diameter is reduced in diameter by a self-restoring force and is fitted into the groove 2a1, so that the protector 7 is fixed to the outer periphery of the outer tube 2 in a state in which the entire inner periphery of the protector main body 7a is positioned at a position facing the outer periphery of the protector mounting portion 2a.

When the protector 7 is fixed to the protector mounting portion 2a in this manner, the upper end in FIG. 1, which is a non-rod-side end of the protector 7, and the upper end in FIG. 1, which is a non-rod-side end of the protector mounting portion 2a, are disposed at the same height to form a flush surface. Therefore, a worker who mounts the protector 7 on the outer periphery of the outer tube 2 can grasp that the fixing projection 7b of the protector 7 is fitted into the groove 2a1 and the protector 7 is fixed to the outer tube 2 at a correct mounting position only by visually recognizing that an upper end surface of the protector 7 and an upper end surface of the protector mounting portion 2a are flush with each other. Therefore, the worker who mounts the protector 7 on the outer periphery of the outer tube 2 can visually confirm whether or not the fixing of the protector 7 to the outer tube 2 is finished, so that the worker can easily grasp the completion of the fixing of the protector 7 to the outer tube 2. When the protector 7 is mounted on the protector mounting portion 2a of the outer tube 2, the protector 7 protrudes outward in the radial direction from the outer periphery of the outer tube 2, and faces, in the radial direction, an inner periphery of the vicinity of the center of the coil spring 6 in the axial direction.

In the shock absorber D configured as described above, when the rod 3 enters the outer tube 2 due to a compression operation and the coil spring 6 is compressed by an approach of the outer-tube-side spring seat 4 and the rod-side spring seat 5, the coil spring 6 buckles and is bent around the center, and the vicinity of the center approaches the outer tube 2. Even if the coil spring 6 buckles and the vicinity of the center approaches the outer periphery of the outer tube 2 in this manner, the protector 7 abuts on an inner peripheral side of a wire of the coil spring 6, so that the approach of the coil spring 6 to the outer tube 2 is restricted, and contact between the coil spring 6 and the outer tube 2 is prevented.

In addition, when the protector 7 is mounted on the outer tube 2, there is no need for a stop ring that requires troublesome mounting work, and the protector 7 can be fixed to the outer tube 2 by fitting the fixing projection 7b provided on the inner periphery of the protector 7 into the groove 2a1 of the outer tube 2.

As described above, the shock absorber D according to the present embodiment includes the shock absorber main body 1 that includes the outer tube 2 and the rod 3 inserted into the outer tube 2 so as to be movable in the axial direction and generates the damping force during extension and compression, the outer-tube-side spring seat 4 that is attached to the outer periphery of the outer tube 2, the rod-side spring seat 5 that is attached to the rod 3, the coil spring 6 that is interposed between the outer-tube-side spring seat 4 and the rod-side spring seat 5 in a state in which the outer tube 2 and the rod 3 are inserted into the inner periphery of the coil spring 6, and the protector 7 that covers a part of the outer periphery of the outer tube 2 to prevent an interference between the coil spring 6 and the outer tube 2, in which the groove 2a1 is provided on the outer periphery of the protector mounting portion 2a on which the protector 7 is mounted, and the protector 7 includes the tubular protector main body 7a and the fixing projection 7b that is provided on the inner periphery of the protector main body 7a and fitted into the groove 2a1 to fix the protector main body 7a to the outer tube 2.

In the shock absorber D configured as described above, even when the coil spring 6 buckles and is bent around the vicinity of the center due to the compression operation, and the vicinity of the center of the coil spring 6 approaches the outer periphery of the outer tube 2, the protector 7 abuts on the inner peripheral side of the wire of the coil spring 6, so that an interference between the coil spring 6 and the outer tube 2 can be prevented. In the shock absorber D configured as described above, when the protector 7 is fixed to the outer tube 2, the protector 7 can be easily assembled to the outer tube 2 by fitting the fixing projection 7b of the protector 7 into the groove 2a1 formed on the outer periphery of the outer tube 2 without requiring two stopper rings as in the shock absorber according to the related art.

In addition, since the protector 7 is fixed to the outer tube 2 by fitting the fixing projection 7b provided on the inner periphery of the protector main body 7a into the groove 2a1 on the outer periphery of the protector mounting portion 2a, and the protector 7 does not have a C shape like the stopper ring, there is no concern that the fixing projection 7b is expanded in diameter and comes out of the groove 2a1 even when a force in the axial direction is applied. Therefore, the protector 7 can be firmly fixed to the outer tube 2.

As described above, in the shock absorber D of the present embodiment, it is easy to assemble the protector 7 when fixing the protector 7 to the outer tube 2, and the protector 7 can be firmly fixed to the outer tube 2, so that assembly work can be improved and detachment of the protector 7 can be prevented.

Further, the fixing projection 7b of the present embodiment is provided on the inner periphery of the rod-side end which is the lower end of the protector main body 7a in FIG. 1. In the shock absorber D configured as described above, a diameter expansion amount of the protector main body 7a when the fixing projection 7b rides up onto the protector mounting portion 2a can be reduced, deterioration of the protector 7 when the protector 7 is mounted on the outer tube 2 can be suppressed, a length in the axial direction, by which the cylindrical portion 101b of the jig 100 and the rod-side end portion 2b of the outer tube 2 face each other, can be secured when the outer tube 2 is temporarily inserted into the protector 7, and when the protector 7 is pushed toward the outer tube 2 by the jig 100, axial run-out of the jig 100 is less likely to occur with respect to the outer tube 2, and a stable load can be applied to the protector 7, so that stable assembly work can be performed.

On the other hand, for example, when the fixing projection 7b is provided at a non-rod-side end of the protector main body 7a, the protector main body 7a protrudes outward from the rod-side end of the outer tube 2 when the outer tube 2 is temporarily inserted into the protector 7, and the jig 100 cannot be guided by the outer tube 2. Therefore, it can be easily understood that the assembly work can be stably performed by providing the fixing projection 7b on the inner periphery of the rod-side end of the protector main body 7a.

Further, in the shock absorber D of the present embodiment, the outer tube 2 includes the rod-side end portion 2b provided on the outer periphery, positioned on the rod side with respect to the protector mounting portion 2a, and having the outer diameter smaller than the outer diameter of the protector mounting portion 2a, and the tapered portion 2c provided on the outer periphery between the rod-side end portion 2b and the protector mounting portion 2a and having the outer diameter increasing from the rod-side end portion 2b toward the protector mounting portion 2a.

In the shock absorber D configured as described above, when the protector 7 is pushed toward the outer tube 2, moved toward the protector mounting portion 2a, and mounted on the protector mounting portion 2a, the fixing projection 7b can be smoothly expanded in diameter following the tapered portion 2c, and the fixing projection 7b can be fitted into the groove 2a1 without difficulty, so that the assembly work is facilitated.

Further, in the shock absorber D of the present embodiment, the outer tube 2 includes the small-diameter portion 2d provided on the outer periphery, positioned on the non-rod side with respect to the protector mounting portion 2a, and having the outer diameter smaller than the outer diameter of the protector mounting portion 2a, and the non-rod-side end of the protector mounting portion 2a and the non-rod-side end of the protector main body 7a mounted on the protector mounting portion 2a are flush with each other in the axial direction.

In the shock absorber D configured as described above, the worker who mounts the protector 7 on the outer periphery of the outer tube 2 can grasp that the fixing projection 7b of the protector 7 is fitted into the groove 2a1 and the protector 7 is fixed to the outer tube 2 at a correct mounting position only by visually recognizing that the upper end surface of the protector 7 and the upper end surface of the protector mounting portion 2a are flush with each other. Therefore, in the shock absorber D of the present embodiment, the worker who mounts the protector 7 on the outer periphery of the outer tube 2 can visually confirm whether or not the fixing of the protector 7 to the outer tube 2 is finished, so that the worker can easily grasp the completion of the fixing of the protector 7 to the outer tube 2.

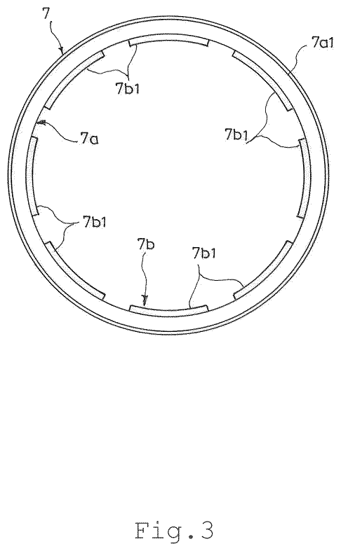

In the shock absorber D of the present embodiment, the outer tube 2 is coupled to the sprung member of the straddled vehicle, and the rod 3 is coupled to the unsprung member of the straddled vehicle, so that the shock absorber D is used as a so-called inverted type shock absorber. As described above, in a case where the shock absorber D of the present embodiment is used in an inverted orientation, when rainwater enters a gap between the inner periphery of the protector main body 7a and the outer periphery of the protector mounting portion 2a from between an upper end of the protector 7 in FIG. 1 and an upper end of the protector mounting portion 2a, there is a possibility that the rainwater entering the gap is not drained from the gap because the annular fixing projection 7b is fitted in the annular groove 2a1. Therefore, in a case where the shock absorber D is used in the inverted orientation or the fixing projection 7b is provided on the inner periphery of the protector main body 7a so as to be closer to the non-rod-side end than to the rod-side end, as illustrated in FIG. 3, the fixing projection 7b of the protector 7 may be implemented by a plurality of protrusions 7b1 intermittently provided on the inner periphery of the protector main body 7a in the peripheral direction, so that a gap that allows rainwater to pass may be formed between the adjacent protrusions 7b1 to achieve smooth drainage. In a case where the shock absorber D is used in an upright orientation and the annular fixing projection 7b is provided on the inner periphery of the rod-side end of the protector main body 7a and fitted into the groove 2a1, rainwater can be blocked by the fixing projection 7b to prevent rainwater from entering the gap between the protector main body 7a and the protector mounting portion 2a.

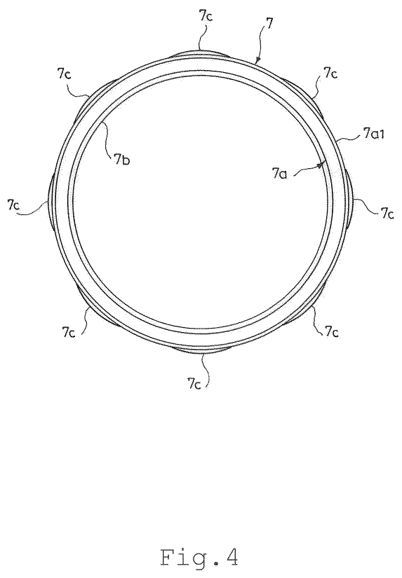

In addition, as illustrated in FIG. 4, in a case where the protector 7 includes a plurality of ribs 7c formed in the axial direction and provided side by side in the peripheral direction on the outer periphery of the protector main body 7a, even if the coil spring 6 buckles during the compression operation of the shock absorber D, the ribs 7c abut on the wires of the coil spring 6, so that a frictional force generated between the coil spring 6 and the ribs 7c is reduced to hinder the expansion and compression of the shock absorber D, so that application of an unnecessary resistance that cannot be controlled is prevented. Therefore, riding comfort of the straddled vehicle can be improved. In addition, during compression of the coil spring 6, when the wire of the coil spring 6 rotates around an axis of the coil spring 6 and abuts on the rib 7c of the protector 7, the protector 7 is rotated. Therefore, the protector 7 rotates slightly, and a contact portion of the wire of the coil spring 6 with respect to the rib 7c changes little by little, so that uneven wear of the rib 7c can be suppressed.

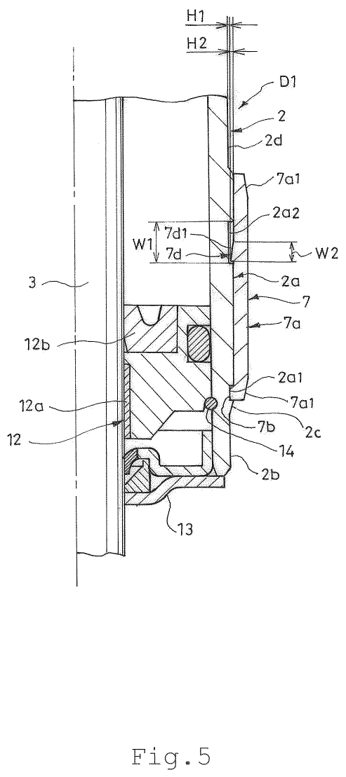

Furthermore, in order to prevent the protector 7 from being detached from the outer tube 2, as in a shock absorber D1 according to a modified example of one embodiment illustrated in FIG. 5, an auxiliary groove 2a2 provided on the outer periphery of the protector mounting portion 2a of the outer tube 2 at a position different from an installation position of the groove 2a1 in the axial direction may be provided, and an auxiliary protrusion 7d that is provided on the inner periphery of the protector main body 7a of the protector 7 and is fittable into the auxiliary groove 2a2 may be provided.

In the shock absorber D1 according to the modified example of one embodiment, the outer tube 2 includes the annular auxiliary groove 2a2 formed over the entire periphery in the peripheral direction on the outer periphery of the protector mounting portion 2a at a position shifted from the installation position of the groove 2a1 in the axial direction.

The protector 7 mounted on the protector mounting portion 2a includes the annular auxiliary protrusion 7d provided in the peripheral direction at a position facing the auxiliary groove 2a2 on the inner periphery of the protector main body 7a in a state in which the fixing projection 7b is fitted into the groove 2a1.

The auxiliary protrusion 7d has a tapered surface 7d1 provided on an inner periphery and positioned on an upper end side in FIG. 5, which is a non-rod-side. A height H1 of the auxiliary protrusion 7d in the radial direction is lower than a height H2 of the fixing projection 7b in the radial direction, and a width W2 of the auxiliary protrusion 7d in the axial direction is smaller than a width W1 of the auxiliary groove 2a2 in the axial direction. That is, the width W1 of the auxiliary groove 2a2 in the axial direction is larger than the width W2 of the auxiliary protrusion 7d in the axial direction.

When the protector 7 is pushed toward the outer tube 2 while the lower end of the outer tube 2 in FIG. 5 is inserted into the protector 7 configured as described above, the auxiliary protrusion 7d rides up onto the tapered portion 2c to gradually increase the diameter of the protector main body 7a, and enters the groove 2a1. Further, when the protector 7 is pushed toward the outer tube 2 from this state, the tapered surface 7d1 of the auxiliary protrusion 7d rides up onto a non-rod side edge of the groove 2a1, the protector main body 7a is expanded in diameter again, and the auxiliary protrusion 7d rides up onto the outer periphery of the protector mounting portion 2a over the groove 2a1. When the protector 7 is further pushed toward the outer tube 2, the auxiliary protrusion 7d eventually enters the auxiliary groove 2a2, and the fixing projection 7b is fitted into the groove 2a1, so that the protector 7 is fixed to the outer tube 2.

Since the width W1 of the auxiliary groove 2a2 in the axial direction is larger than the width W2 of the auxiliary protrusion 7d in the axial direction, and the fixing projection 7b can be fitted into the groove 2a1 in a state in which the auxiliary protrusion 7d is inserted into the auxiliary groove 2a2, even if the auxiliary protrusion 7d is inserted into the auxiliary groove 2a2, the fitting of the fixing projection 7b into the groove 2a1 is not hindered. When the fixing projection 7b is fitted into the groove 2a1, the protector 7 is fixed to the protector mounting portion 2a of the outer tube 2.

The shock absorber D1 according to the modified example of one embodiment includes the auxiliary groove 2a2 provided at a position different from the installation position of the groove 2a1 in the axial direction on the outer periphery of the protector mounting portion 2a, the protector 7 includes the auxiliary protrusion 7d that is provided on the inner periphery of the protector main body 7a and is fittable into the auxiliary groove 2a2, and the width of the auxiliary groove 2a2 in the axial direction is larger than the width of the auxiliary protrusion 7d in the axial direction.

In the shock absorber D1 configured as described above, since the fitting of the auxiliary protrusion 7d into the auxiliary groove 2a2 is made in addition to the fitting of the fixing projection 7b into the groove 2a1, even if the fixing projection 7b is detached from the groove 2a1, the fitting of the auxiliary protrusion 7d into the auxiliary groove 2a2 can prevent the protector 7 from being detached from the outer tube 2. Even if the auxiliary protrusion 7d is fitted into the auxiliary groove 2a2, the width W1 of the auxiliary groove 2a2 in the axial direction is larger than the width W2 of the auxiliary protrusion 7d in the axial direction. Therefore, even if a dimensional error occurs in the axial direction between an installation position of the protector main body 7a of the fixing projection 7b and the installation position of the groove 2a1 with respect to the protector mounting portion 2a, the fixing projection 7b can be fitted into the groove 2a1, so that the assembly work is not hindered.

The auxiliary groove 2a2 may be disposed on a lower side in FIG. 5, which is a rod side with respect to the groove 2a1, in the protector mounting portion 2a, and the auxiliary protrusion 7d may be disposed on a lower side in FIG. 5, which is a rod side with respect to the fixing projection 7b, on the protector main body 7a. Alternatively, two or more auxiliary grooves 2a2 may be provided, and the number of auxiliary protrusions 7d paired with the auxiliary grooves 2a2 may be the same as the number of the auxiliary grooves 2a2.

Although the preferred embodiment of the present invention has been described in detail above, modifications, variations, and changes can be made thereto without departing from the scope of the claims.

What is claimed is:

1. A shock absorber comprising:
a shock absorber main body that includes an outer tube and a rod inserted into the outer tube so as to be movable in an axial direction and is configured to generate a damping force during extension and compression;
an outer-tube-side spring seat that is attached to an outer periphery of the outer tube;
a rod-side spring seat that is attached to the rod;
a coil spring that is interposed between the outer-tube-side spring seat and the rod-side spring seat in a state in which the outer tube and the rod are inserted into an inner periphery of the coil spring; and
a protector that covers a part of the outer periphery of the outer tube to prevent an interference between the coil spring and the outer tube, wherein
a groove is provided on an outer periphery of a protector mounting portion on which the protector is mounted, and
the protector includes a tubular protector main body and a fixing projection that is provided on an inner periphery of the protector main body and fitted into the groove to fix the protector main body to the outer tube.

2. The shock absorber according to claim 1, wherein
the fixing projection is provided on an inner periphery of a rod-side end of the protector main body.

3. The shock absorber according to claim 1, wherein
the outer tube includes:
a rod-side end portion that is provided on the outer periphery, is positioned on a rod side with respect to the protector mounting portion, and has an outer diameter smaller than an outer diameter of the protector mounting portion; and
a tapered portion that is provided on the outer periphery between the rod-side end portion and the protector mounting portion and has an outer diameter increasing from the rod-side end portion toward the protector mounting portion.

4. The shock absorber according to claim 1, wherein
the outer tube includes a small-diameter portion that is provided on the outer periphery, is positioned on a non-rod side with respect to the protector mounting portion, and has an outer diameter smaller than an outer diameter of the protector mounting portion, and
a non-rod-side end of the protector mounting portion and a non-rod-side end of the protector main body mounted on the protector mounting portion are flush with each other in the axial direction.

5. The shock absorber according to claim 1, wherein
the fixing projection is a plurality of protrusions intermittently provided on the inner periphery of the protector main body in a peripheral direction.

6. The shock absorber according to claim 1, wherein
the outer tube includes
an auxiliary groove that is provided on the outer periphery of the protector mounting portion at a position different from an installation position of the groove in the axial direction,
the protector includes an auxiliary protrusion that is provided on the inner periphery of the protector main body and is fittable into the auxiliary groove, and
a width of the auxiliary groove in the axial direction is larger than a width of the auxiliary protrusion in the axial direction.

7. The shock absorber according to claim 1, wherein
the protector includes
a plurality of ribs formed in the axial direction and provided side by side in a peripheral direction on an outer periphery of the protector main body.
